(19) United States
(12) Patent Application Publication
(10) Pub. No.: US 2026/0341589 A1
(43) Pub. Date: Oct. 29, 2026

(54) Switch with Reduced Eddy Currents

(71) Applicant: Apple Inc., Cupertino, CA (US)

(72) Inventors: Tarek Khedr Abdalla Mealy, San Diego, CA (US); Ahmed G. Radwan, Unterhaching (DE); Zhongning Liu, San Diego, CA (US); Zhang Jin, San Diego, CA (US)

(21) Appl. No.: 19/193,452

(22) Filed: Apr. 29, 2025

(51) Int. Cl. H01F 27/34; H01F 38/14; H04B 1/00; H04B 1/04; H04B 7/005

(52) U.S. Cl. CPC H01F 27/341; H01F 38/14; H04B 1/006; H04B 1/0458; H01F 2038/143; H04B 2001/0408; H04B 7/005

(57) ABSTRACT

Switching circuitry includes multiple switch unit sets, each switch unit set including a plurality of switch units arranged along, and electrically coupled via, a first axis. The switching circuitry also includes one or more traces, and each of the one or more traces are oriented on a second axis. Each of the one or more traces are electrically coupled to respective switch units of each switch unit set, and each of the one or more traces do not extend beyond the multiple switch unit sets on the first axis.

### BACKGROUND

The present disclosure relates generally to a switch, such as a switch used to transmit signals for transmission or reception in wireless communication.

In a wireless communication device, a transmitter and a receiver may each be coupled to at least one antenna to enable the device to transmit and receive wireless (e.g., radio frequency (RF)) signals. For example, a power amplifier (PA) in a transmitter may convert a low-power RF signal to a higher power RF signal to drive the at least one antenna. A PA in a transmitter may include a matching network, and the matching network may include an inductor coupled to one or more switches. The switches may control an inductance of the inductor, allowing resonance frequency adjustments.

However, the switches may be large, as they may include an array of numerous switch units (e.g., transistors) that reduce resistance when the switch is on. Because the switches are large and placed on the core of the inductor, the switches may impact a magnetic field of the inductor, resulting in eddy currents on the inductor. The eddy currents may cause a degradation of the quality factor (Q-factor) of the inductor, which may result in reduced power output of the inductor and thus the power amplifier.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Disclosed embodiments are directed towards an RF switch with an interconnect that reduces eddy currents on an inductor. In an embodiment, the interconnect includes one or more traces that span the switch in a first direction (e.g., horizontally) and connect multiple sets of switch units of the array. Each switch unit of a set is connected to other switch units within the set in a second direction (e.g., vertically). Because switch units within a set are only connected to each other in one direction, currents within the switch are more confined, resulting in a reduced magnetic field induced by the switch. As such, impact by the switch on the magnetic field of the inductor is reduced, mitigating degradation of the Q-factor of the inductor.

### BRIEF DESCRIPTION OF THE DRAWINGS

Various aspects of this disclosure may be better understood upon reading the following detailed description and upon reference to the drawings in which:

FIG. 1 is a block diagram of an electronic device, in accordance with an embodiment;

FIG. 2 is a functional diagram of the electronic device of FIG. 1, in accordance with an embodiment;

FIG. 3 is a schematic diagram of a transmitter of the electronic device of FIG. 1, in accordance with an embodiment;

FIG. 4 is a schematic diagram of a multi-stage amplifier that may be used in the transmitter of FIG. 3, in accordance with an embodiment;

FIG. 5 is a schematic diagram of a matching network including an inductor and one or more switches that may be used in the multi-stage amplifier of FIG. 4, in accordance with an embodiment; and

FIG. 6 is a schematic diagram of a switch that may be included in the matching network of FIG. 5, in accordance with an embodiment; and

FIG. 7 is a plot of relationships between a frequency and a quality factor of an inductor, in accordance with an embodiment.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

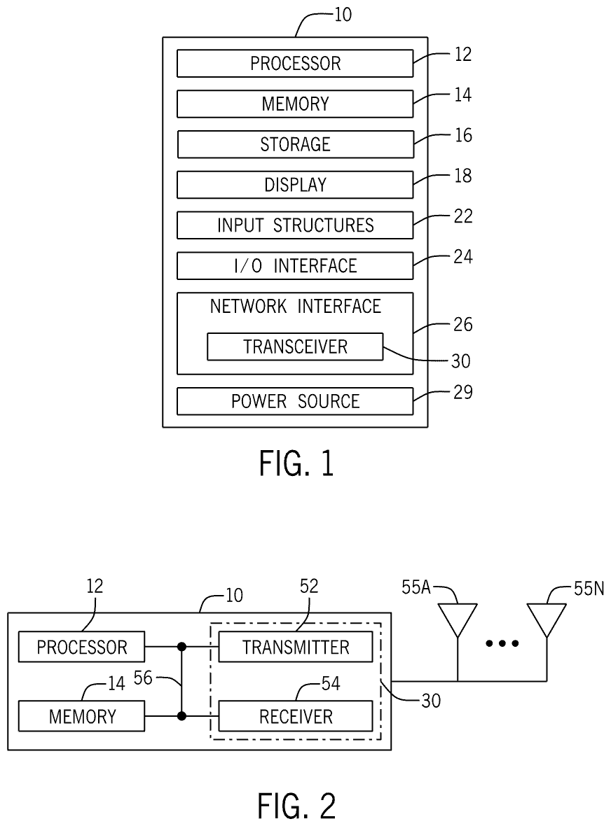

FIG. 1 is a block diagram of an electronic device 10, according to embodiments of the present disclosure. The electronic device 10 includes, among other things, one or more processors 12 (collectively referred to herein as a single processor for convenience, which may be implemented in any suitable form of processing circuitry), memory 14, storage 16, a display 18, input structures 22, an input/output (I/O) interface 24, a network interface 26, and a power source 29. The various functional blocks shown in FIG. 1 include hardware elements (including circuitry), software elements (including machine-executable instructions) or a combination of both hardware and software elements (which may be referred to as logic). The processor 12, memory 14, the storage 16, the display 18, the input structures 22, the input/output (I/O) interface 24, the network interface 26, and/or the power source 29 are each communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in electronic device 10.

By way of example, the electronic device 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 is operably coupled with a memory 14 and a storage 16 to perform various algorithms. Such programs or instructions executed by the processor 12 may be stored in any suitable article of manufacture that includes one or more tangible, computer-readable media. The tangible, computer-readable media includes the memory 14 and/or the storage 16, individually or collectively, to store the instructions or routines. The memory 14 and the storage 16 may include any suitable articles of manufacture for storing data and executable instructions, such as random-access memory, read-only memory, rewritable flash memory, hard drives, and optical discs. In addition, in some embodiments, programs (e.g., an operating system) encoded on such a computer program product also include instructions that are executed by the processor 12 to enable the electronic device 10 to provide various functionalities.

In certain embodiments, the display 18 facilitates users to view images generated on the electronic device 10. In some embodiments, the display 18 includes a touch screen, which facilitates user interaction with a user interface of the electronic device 10. It should be understood that, in some embodiments, the electronic device 10 may not have a display 18, such as in the case of the electronic device 10 being a server, router, communication hub, and so on.

In some embodiments, the input structures 22 of the electronic device 10 enable a user to interact with the electronic device 10 (e.g., pressing a button to increase or decrease a volume level). In some embodiments, the I/O interface 24 enables the electronic device 10 to interface with various other electronic devices, as may the network interface 26. In some embodiments, the I/O interface 24 includes an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, for a local area network (LAN) or wireless local area network (WLAN), such as a network employing one of the IEEE 802.11x family of protocols (e.g., WI-FI®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a satellite network, and so on. In particular, the network interface 26 may include, for example, one or more interfaces for using a Release-15 cellular communication standard of the 5G specifications that include the millimeter wave (mmWave) frequency range (e.g., 24.25-300 gigahertz (GHz)) and/or any other cellular communication standard release (e.g., Release-16, Release-17, any future releases) that define and/or enable frequency ranges used for wireless communication. In some embodiments, the network interface 26 of the electronic device 10 allows communication over the aforementioned networks (e.g., 5G, Wi-Fi, LTE-LAA, and so forth).

In some embodiments, the network interface 26 also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) Network and its Extension Dvb Handheld (DVB-H®) Network, Ultra-wideband (UWB) network, alternating current (AC) power lines, and so forth.

In the illustrated embodiment, the network interface 26 includes a transceiver 30. In some embodiments, all or portions of the transceiver 30 are disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter. In certain embodiments, the electronic device 10 takes the form of a computer, a portable electronic device, a wearable electronic device, or other type of electronic device.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) are communicatively coupled directly or indirectly (e.g., through or via another component, a communication bus, a network) to one another to transmit and/or receive data between one another.

In some embodiments, the electronic device 10 includes the transmitter 52 and/or the receiver 54 that respectively enable transmission and reception of data between the electronic device 10 and an external device via, for example, a network (e.g., including base stations) or a direct connection. As illustrated, the transmitter 52 and the receiver 54 may be combined into the transceiver 30. In some embodiments, the electronic device 10 also has one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with a one or more beams and various configurations. In some embodiments, multiple antennas of the antennas 55A-55N of an antenna group or module are communicatively coupled to a respective transceiver 30. One or more of the antennas 55A-55N may each emit radio frequency signals that may constructively and/or destructively combine to form a beam. In some embodiments, the electronic device 10 includes multiple transmitters, multiple receivers, multiple transceivers, and/or multiple antennas as suitable for various communication standards. In some embodiments, the transmitter 52 and the receiver 54 transmit and receive information via other wired or wireline systems or means.

In the illustrated example, the various components of the electronic device 10 are coupled together by a bus system 56. The bus system 56 may include a data bus, for example, as well as a power bus, a control signal bus, and a status signal bus, in addition to the data bus. In some embodiments, the components of the electronic device 10 are coupled together or accept or provide inputs to each other using some other mechanism.

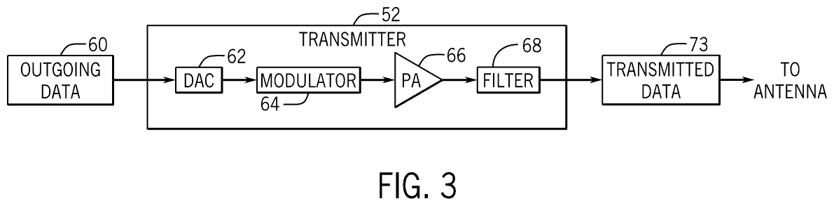

FIG. 3 is a schematic diagram of the transmitter 52 (e.g., transmit circuitry), according to embodiments of the present disclosure. In the illustrated embodiment, the transmitter 52 receives outgoing data 60 in the form of a digital signal to be transmitted via the one or more antennas 55. A digital-to-analog converter (DAC) 62 of the transmitter 52 converts the digital signal to an analog signal, and a modulator 64 combines the converted analog signal with a carrier signal to generate a radio wave. A power amplifier (PA) 66 receives the modulated signal from the modulator 64. In the illustrated embodiment, the power amplifier 66 amplifies the modulated signal to a suitable level to drive transmission of the signal via the one or more antennas 55. A filter 68 (e.g., filter circuitry and/or software) of the transmitter 52 then removes undesirable noise from the amplified signal to generate transmitted signal 70 to be transmitted via the one or more antennas 55. In some embodiments, the filter 68 includes any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE) 69, and more specifically, a transmit front end (TXFE) of the electronic device 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

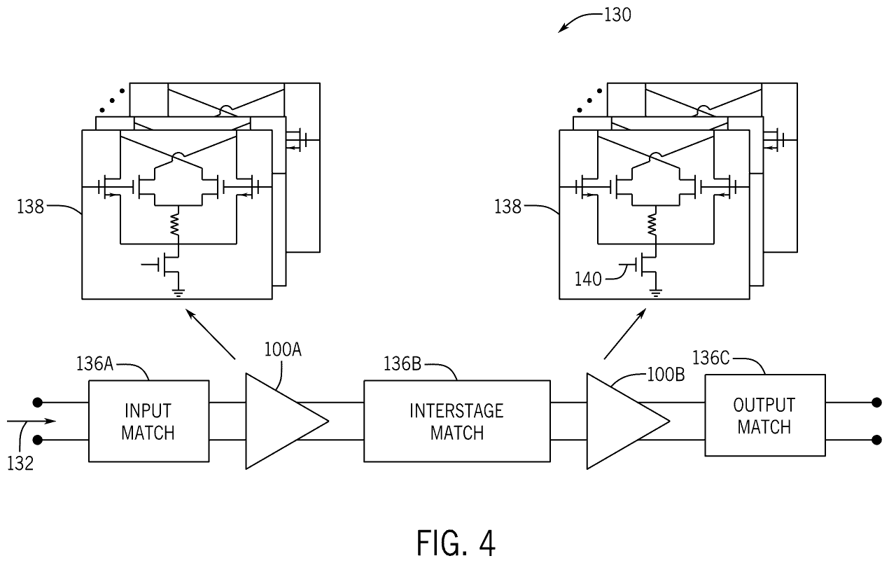

FIG. 4 is a schematic diagram of a multi-stage amplifier 130 that mis used in the transmitter 52 of the electronic device 10, according to embodiments of the present disclosure. As the name suggests, the multi-stage amplifier 130 amplifies power of an input signal 132 received at an input terminal 133 in multiple stages, where each stage corresponds to an amplifier 100. As illustrated, a first amplification stage corresponds to a first amplifier 100A, and a second amplification stage corresponds to a second amplifier 100B. The multi-stage amplifier 130 also include matching networks 136A, 136B, 136C (collectively 136) that match impedances between unequal input impedances and output impedances. In the illustrated embodiment, the matching networks include an input matching network 136A that matches an impedance between the input terminal 133 and an input of the first amplifier 100A, an interstage matching network 136B that matches an impedance between an output of the first amplifier 100A and an input of the second amplifier 100B, and an output matching network 136C that matches an impedance between an output of the second amplifier 100B and an output terminal 137. In some embodiments, the multi-stage amplifier 130 also include attenuators that attenuate or reduce an amplitude of the input signal 132.

In some embodiments, the amplifiers 100 each include multiple instances of amplification circuitry 138. For example, each amplifier 100 may have two or more, three or more, four or more, eight or more, and so on, instances of amplification circuitry 138. Each amplification circuitry 138 may be coupled in parallel to one another within each amplifier 100, and have a respective switch 140 to activate (or couple to an operating circuit of the multi-stage amplifier 130) each amplification circuitry 138. Opening or closing each respective switch 140 to activate or deactivate each amplification circuitry 138 may vary the gain for an amplifier 100. Enabling each amplification circuitry 138 to couple to or uncouple from an operating circuit of the multi-stage amplifier 130 provides tunability, with each independent amplification circuitry 138 being neutralized internally and separately from other amplification circuitries 138.

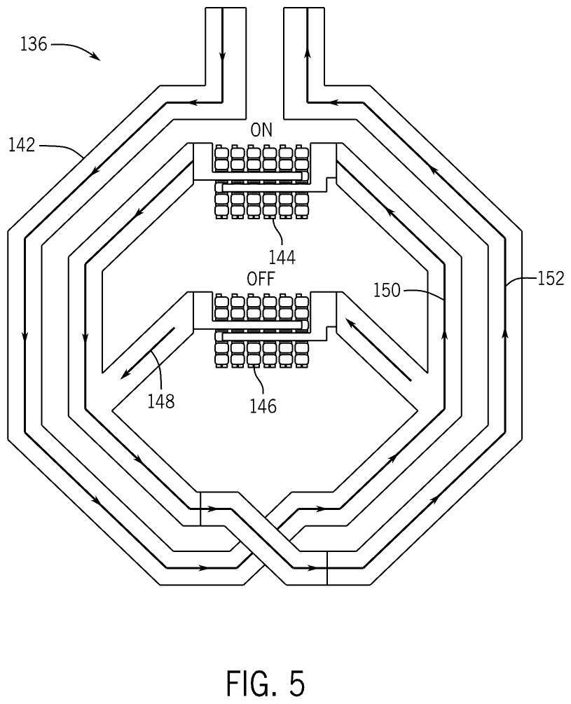

FIG. 5 is a schematic illustration of a portion of the matching network 136 that includes an inductor 142 coupled to an on switch 144 and an off switch 146. In the illustrated embodiment, an inductance of the inductor 142 is varied by opening or closing the on switch 144 and the off switch 146. For example, when the on switch 144 is closed, current circulates about a smaller loop 148, which may cause the inductor 142 to have a high inductance. When the off switch 146 is closed, current circulates about a larger loop 150, which may cause the inductor 142 to have a relatively low inductance. As such, by closing and opening the switches 144 and 146, an inductance of the matching network 136 is adjusted to match impedances between unequal input impedances and output impedances (e.g., of the multi-stage amplifier 130). In some embodiments, varying the inductance of the inductor 142 also tunes a frequency of the matching network 136. The inductor includes additional paths (e.g., coils), such as the path 152, that may be included as part of the smaller loop 148 and/or the larger loop 150. Further, while illustrated as individual paths, the inner loop 148 and/or the outer loop 150 may include multiple paths (e.g., parallel paths) for current to travel.

Further, while shown as one inductor 142, in some embodiments, the matching network 136 includes multiple inductors coupled to the switches 144 and 146 and/or additional switches. For example, the matching network 136 may include a primary inductor and a secondary inductor coupled to the switches 144 and 146. In such cases, the matching network 136 may include or be used as a transformer that increases or decreases a voltage, resistance, or the like.

Each of the switches 144 and 146 have a respective resistance when closed, which may impact a power output of the inductor 142. Additionally, current flowing through the inductor 142 may induce currents (e.g., eddy currents) within the switches 144 and/or 146 when closed. In the illustrated embodiment, the switches 144 and/or 146 are arranged beneath the inductor 142, and a magnetic field induced by current flowing through the inductor 142 induces eddy currents within the switches 144 and/or 146 in a clockwise direction. The eddy currents of the switches 144 and/or 146 cause a magnetic field at the inductor 142, and the magnetic field changes a quality factor, also referred to herein as a Q value or Q factor, of the inductor (e.g., a ratio of the inductive reactance of the inductor 142 to a resistance of the inductor 142 at a certain frequency). For optimal performance of the matching network 136, it may be desirable to maximize the quality factor of the inductor 142 across varying frequencies. As such, it may be desirable to mitigate or reduce the currents within the switches 144 and 146 to allow the quality factor and power output of the inductor 142 to remain suitably high across frequencies.

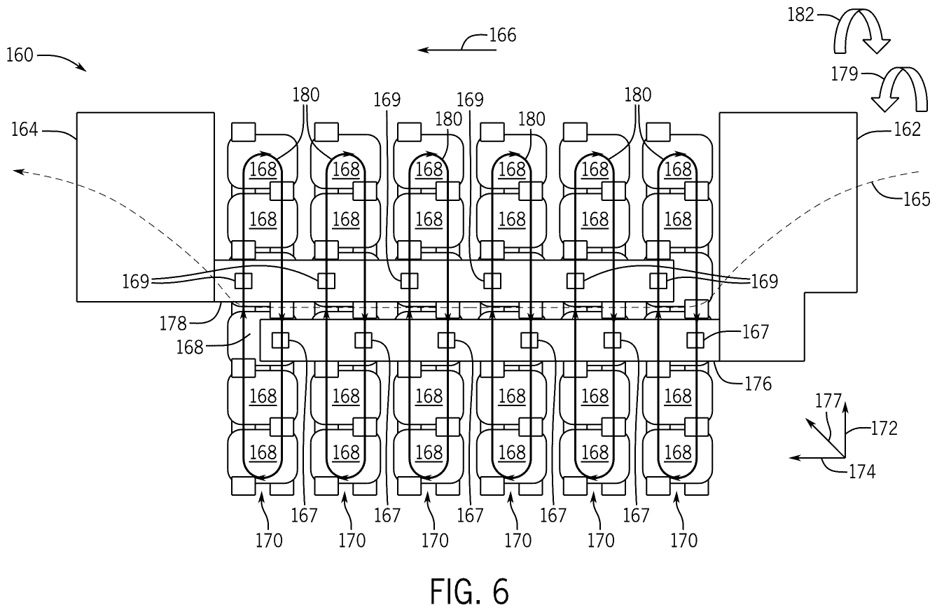

FIG. 6 is an illustration of a switch 160 (e.g., switching circuitry) that is selectively closed or opened to adjust an inductance, and thus a frequency, of an inductor. Additionally, the switch 160 mitigates degradation of the quality factor and power output of a connected inductor by confining eddy currents 180 within the switch 160. In the illustrated embodiment, confining the eddy currents 180 reduces magnetic fields induced by the eddy currents 180, reducing an overall effect of the eddy currents 180 on a connected inductor. The switch 160 may represent, for example, the on switch 144 or the off switch 146 of FIG. 5.

In the illustrated embodiment, the switch 160 electrically couples to the inductor 142 via a terminal 162 and a terminal 164. In an embodiment, the terminal 162 is a positive terminal and the terminal 164 is a negative terminal. In other embodiments, the terminal 162 is a negative terminal and the terminal 164 is a positive terminal. Further, in some embodiments, the switch 160 electrically couples to the inductor 142 via more than two terminals. For example, the switch 160 may have more than one positive terminal and/or more than one negative terminal, such as a negative and positive terminal coupled to each path or coil of an inductor.

The switch 160 includes a plurality of switch units 168, here illustrated as transistors, and the switch units 168 are arranged in an array. In the illustrated example, the switch units 168 are arranged in an array having six switch units sets 170, each switch unit set 170 having six switch units 168. Within each switch unit set 170, each switch unit 168 is electrically coupled to one or more adjacent switch units 168 in a y axis 172 perpendicular to the x axis 174. This allows currents to flow between the switch units 168 of a switch unit set 170 in the y axis 172. It should be noted that, while the switch units 168 are arranged in a six-by-six array in the illustrated embodiments, different numbers and arrangements of switch units 168 may be included in the switch 160. In some embodiments, the switch includes more or fewer switch units 168 in the y axis 172 and/or more or fewer switch units 168 in the x axis 174, which varies an overall resistance of the switch 160. In particular, while shown as a six-by-six array of switch units 168, in some embodiments, the switch 160 includes significantly more switch units (e.g., a ten-by-ten array, between 5 and 20 switch unit sets of between 5 and 20 switch units, hundreds or thousands of total switch units) to reduce an overall resistance of the switch 160. Further, in some cases, the switch 160 includes additional switch units in a z direction 177 orthogonal to the x axis 174 and the y axis 172. For example, the switch 160 may include another six-by-six array of switch units arranged above or below the switch units 168, and the additional switch units may be connected to additional terminals via additional traces.

However, in the illustrated embodiment, switch units 168 of a switch unit set 170 are not electrically coupled to switch units 168 of other switch unit sets 170 in an x axis 174. Each of the switch unit sets 170 may be physically separated or otherwise electrically insulated from other switch unit sets 170. That is, current does not flow between individual switch units 168 of a switch unit set 170 and individual switch units 168 of an adjacent switch unit set 170. Instead, the switch unit sets 170 is electrically coupled to each other via respective traces 176 and 178 of the terminals 162 and 164 oriented along the x axis 174. The trace 176 connects to a switch unit 168 (e.g., a respective switch unit, middle switch unit) of each switch unit set 170 at respective nodes 167, and the trace 178 connects to a switch unit 168 of each switch unit set 170 at respective nodes 169. As such, a primary current 165 flows in a direction 166 from the terminal 162 to the terminal 164 through the traces 176 and 178, while flowing in the y axis 172 through respective switch units 168 of each switch unit set 170 (e.g., via the middle switch unit 168 and corresponding outer switch units 168). The terminals 162 and 164 and corresponding traces 176 and 178 may be collectively referred to herein as an interconnect of the switch 160.

Further, in some embodiments, the switch 160 includes additional terminals and/or additional traces connected to additional terminals. In an example, the switch 160 includes an additional trace connected to each of the terminals 162 and 164 and each of the switch unit sets 170. An additional trace is connected to the terminal 162 and each switch unit set 170 via additional nodes, and the additional nodes are arranged between the nodes 169 and an outermost switch unit 168 on the y axis 172, for instance. That is, additional traces may be arranged in a central portion of the array of switch units 168, as with the traces 176 and 178.

As mentioned, in the illustrated embodiment, the switch 160 is arranged beneath an inductor, such as the inductor 142 of FIG. 5 (e.g., such that the inductor is above the switch 160 in a z direction 177). Further, because currents of the inductor may flow in a counterclockwise direction 179, the inductor induces a magnetic field that induces eddy currents 180 within the switch 160. As illustrated, the eddy currents 180 may flow through the switch units 168 of each switch unit set 170 in a clockwise direction 182.

However, because switch units 168 of each switch unit set 170 are not electrically coupled to switch units 168 of other switch unit sets 170 in the x axis 174, paths of the eddy currents 180 are constrained in the x axis 174. This may reduce an overall magnitude of a magnetic field induced by each of the eddy currents 180. Additionally, the traces 176 and 178 are coupled to the switch unit sets 170 at switch units 168 (e.g., middle switch units) that are located near the center of the array of switch units 168 in the y axis 172 (e.g., with respect to outer switch units). That is, the traces 176 and 178 do not extend to or beyond outermost switch units 168 in the y axis 172. As such, the eddy currents 180 do not directly oppose the primary current 165 at the traces 176 and 178 (e.g., may not flow directly opposite the direction 166). Finally, because the eddy currents 180 run parallel (e.g., substantially parallel) to each other, magnetic fields induced by the eddy currents 180 are countervailed (e.g., substantially offset) by magnetic fields produced by other eddy currents 180. As such, magnetic fields induced by the eddy currents 180 are substantially reduced, which mitigates degradation of a quality factor or power output of an inductor arranged near the switch 160.

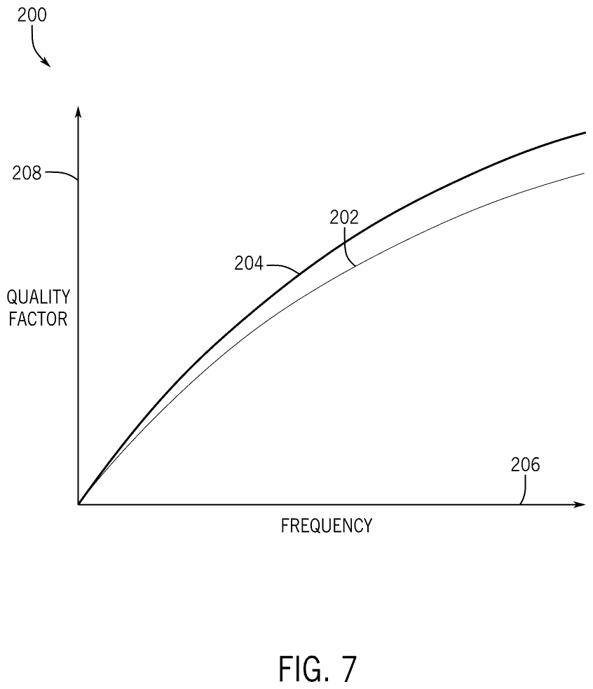

To illustrate, FIG. 7 is a plot 200 of relationships 202 and 204 between a frequency 206 and a quality factor (Q factor) 208 of an inductor (e.g., the inductor 142). As mentioned, in some embodiments, eddy currents of switches coupled to an inductor (e.g., the switches 144 and/or 146) cause a magnetic field at the inductor 142, and the magnetic field changes the quality factor 208 of the inductor. The quality factor 208 includes a ratio of the inductive reactance of the inductor 142 to a resistance of the inductor 142 at a certain frequency 206. For optimal performance of the inductor, it may be desirable to maximize the quality factor 208 of the inductor across varying frequencies 206. As such, it may be desirable to mitigate or reduce the currents within switches coupled to the inductor to allow the quality factor 208 and power output of the inductor to remain suitably high across frequencies 206.

The plot 200 includes a first relationship 202 between the frequencies 206 and the quality factor 208 in which the inductor is coupled to switches without the disclosed interconnect (e.g., without the terminals 162 and 164 and corresponding traces 176 and 178). Without the interconnect, eddy currents within a switch coupled to the inductor are not confined, and the resultant magnetic field reduces the quality factor 208 of the inductor across the frequencies 206. As such, a power output of the inductor may be degraded.

The plot 200 also includes a second relationship 204 between the frequencies 206 and the quality factor 208 in which the inductor is coupled to switches that include the disclosed interconnect (e.g., as in the switch 160, including the terminals 162 and 164 and corresponding traces 176 and 178). As discussed herein, inclusion of the interconnect reduces a size or magnitude of eddy currents within the switches, thus reducing a magnetic field induced by the eddy currents. Additionally, because traces of the interconnect (e.g., the traces 176 and 178) do not extend to or beyond outermost switch units in a y axis, the eddy currents do not directly oppose a primary current flowing through the inductor. Further, because eddy currents within the switch run parallel to each other, magnetic fields induced by the eddy currents are countervailed by magnetic fields produced by other eddy currents. As such, magnetic fields induced by the eddy currents may be substantially reduced, which may mitigate degradation of a quality factor 208 and/or power output of the inductor arranged near the switch.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ,” it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. Switching circuitry comprising:
a plurality of switch unit sets, each switch unit set comprising a plurality of switch units arranged along, and electrically coupled via, a first axis; and
one or more traces, each of the one or more traces oriented on a second axis, each of the one or more traces electrically coupled to respective switch units of each switch unit set, each of the one or more traces not extending beyond the plurality of switch unit sets on the first axis.

2. The switching circuitry of claim 1, wherein the first axis is perpendicular to the second axis.

3. The switching circuitry of claim 1, wherein the one or more traces are configured to carry an inductor current between the one or more switch unit sets.

4. The switching circuitry of claim 3, wherein the one or more traces are configured to carry the inductor current from a coil of an inductor to a first respective switch unit of the respective switch units.

5. The switching circuitry of claim 4, wherein the one or more traces are configured to carry the inductor current from a second respective switch unit of the respective switch units to the coil of the inductor.

6. The switching circuitry of claim 1, wherein each of the switch unit sets comprises:
a first outer switch unit adjacent to the respective switch unit in a first direction of the first axis; and
a second outer switch unit adjacent to the respective switch unit in a second direction of the first axis.

7. The switching circuitry of claim 1, wherein the one or more traces are not connected to switch units that are not the respective switch units of each switch unit set.

8. The switching circuitry of claim 1, wherein the plurality of switch units of a switch unit set of the plurality of switch unit sets comprises a transistor.

9. The switching circuitry of claim 1, comprising ten or more switch unit sets.

10. The switching circuitry of claim 9, wherein each switch unit set comprises ten or more switch units.

11. A matching network, comprising:
an inductor having an inductance and comprising one or more paths, the inductance varying based on current flowing through the one or more paths; and
one or more switches, each configured to selectively open and close to carry current through a path of the one or more paths, each of the one or more switches comprising:
an array of transistors, wherein each transistor of the array of transistors is physically separated from other transistors of the array on a first axis; and
an interconnect electrically coupling the path to the array of transistors via one or more middle transistors of the array of transistors.

12. The matching network of claim 11, wherein each transistor of the array of transistors is electrically coupled to one or more adjacent transistors of the array of transistors on a second axis perpendicular to the first axis.

13. The matching network of claim 12, wherein the one or more paths comprise one or more coils of the inductor, and wherein the one or more coils are arranged above the one or more switches on a third axis, the third axis orthogonal to the first axis and the second axis.

14. The matching network of claim 11, wherein the interconnect comprises:
one or more terminals configured to carry the current flowing through the one or more paths from the inductor to one or more traces; and
the one or more traces configured to carry the current between the one or more middle transistors.

15. The matching network of claim 14, wherein each of the one or middle transistors is configured to carry the current from a trace of the one or more traces to one or more corresponding transistors of the array of transistors.

16. The matching network of claim 11, wherein the matching network comprises a primary inductor and a secondary inductor, each having a respective inductance and comprising the one or more paths.

17. A switch, comprising:
a transistor array, wherein one or more transistors of the transistor array are coupled on a first axis and physically separated from other transistors of the transistor array on a second axis, the second axis orthogonal to the first axis, the one or more transistors configured to carry a current along the second axis; and
an interconnect configured to carry the current on the first axis between the one or more transistors and the other transistors of the transistor array.

18. The switch of claim 17, wherein the interconnect is electrically coupled to one or more middle transistors of the one or more transistors.

19. The switch of claim 18, wherein the interconnect comprises one or more circuit traces configured to carry the current from the one or more middle transistors to one or more terminals.

20. The switch of claim 19, wherein the one or more terminals couple the switch to a coil of an inductor.
